(19) United States
(12) Patent Application Publication
(10) Pub. No.: US 2026/0190199 A1
(43) Pub. Date: Jul. 2, 2026

(54) LIGHT CONTROL INSTRUCTION EXTENSION DEVICE AND INSTRUCTION SET

(71) Applicant: ELKA INTERNATIONAL LTD., New Taipei (TW)

(72) Inventors: Yi-Chieh CHENG, New Taipei (TW); Yen-Tung CHEN, New Taipei (TW)

(21) Appl. No.: 19/422,916

(22) Filed: Dec. 17, 2025

(30) Foreign Application Priority Data
Dec. 30, 2024 (TW) 113151536

(51) Int. Cl. H05B 47/105; H05B 45/20; H05B 45/22; H05B 47/11; H05B 47/155; H05B 47/16; H05B 47/175; H05B 47/19

(52) U.S. Cl. CPC H05B 47/105; H05B 45/20; H05B 45/22; H05B 47/11; H05B 47/155; H05B 47/16; H05B 47/19; H05B 47/196

(57) ABSTRACT

A light-control instruction extension device is provided. The device includes an input interface, a processing unit, and an output interface. The input interface is configured to receive a light-control instruction from a light-control instruction source. The processing unit is configured to receive the light-control instruction and generate an extended light-control instruction. The light-control instruction corresponds to a first number of light-emitting elements, while the extended light-control instruction corresponds to a second number of light-emitting elements, wherein the second number is greater than the first number. The output interface is configured to output the extended light-control instruction, thereby enabling control of a larger number of light-emitting elements than natively supported by the light-control instruction source.

### CROSS-REFERENCE TO RELATED APPLICATION

This application claims priority to Tiawan Patent Application No. 113151536 filed on Dec. 30, 2024, the contents of which are incorporated herein by reference in its entirety.

### TECHNICAL FIELD

The present invention relates to a light-control instruction extension device and an associated instruction set.

### BACKGROUND

With the development of electronic products featuring lighting effects (for example, gaming devices or devices with decorative lighting), the demand for more diverse light-control effects and an increased number of controllable lighting elements has gradually risen. However, devices equipped with lighting control functions, such as computers, have inherent limitations on the number of controlled lighting elements. Accordingly, when, for example, a lighting strip including a relatively large number of serially connected light-emitting elements is incorporated into an electronic device, a lighting-control interface of the electronic device may be unable to control all of the light-emitting elements. This may result in abnormal lighting effects, such as certain light-emitting elements failing to emit light properly.

In view of the above, it is evident that the prior art still suffers from problems such as insufficient or incomplete light-control instructions, which require improvement and resolution.

### SUMMARY

Accordingly, the present invention provides a light-control instruction extension device and an instruction set, so as to effectively resolve various problems encountered in the prior art.

One objective of the present invention is to provide a device and an instruction set capable of extending insufficient light-control instructions.

In an embodiment of the present invention, a light-control instruction extension device is provided. The light-control instruction extension device includes an input interface, a processing unit, and an output interface. The input interface is configured to receive a light-control instruction from a light-control instruction source. The processing unit is configured to receive the light-control instruction and to output an extended light-control instruction. The light-control instruction corresponds to a first number of light-emitting elements, and the extended light-control instruction corresponds to a second number of light-emitting elements, wherein the first number is smaller than the second number. The output interface is configured to output the extended light-control instruction.

In an embodiment, the processing unit repeats at least a portion of the light-control instruction to generate the extended light-control instruction.

In an embodiment, the number of repetitions of the at least a portion of the light-control instruction performed by the processing unit is equal to a quotient obtained by dividing the second number by the first number.

In an embodiment, the processing unit further receives an adjustment command, wherein the adjustment command indicates the number of repetitions of the at least a portion of the light-control instruction.

In an embodiment, the input interface is an ARGB interface.

In an embodiment, the light-control instruction source is a motherboard.

In an embodiment, the light-emitting element is a single-wire RGB light-emitting diode (LED).

In another embodiment of the present invention, an instruction set for extending a light-control instruction is provided. The instruction set is stored in a storage medium. When a processing unit reads the instruction set from the storage medium, the instruction set causes the processing unit to: read the light-control instruction; and repeat outputting at least a portion of the light-control instruction according to a repetition count.

In an embodiment, the light-control instruction corresponds to a first number of light-emitting elements, and the repetition count is an integer multiple of the first number.

In an embodiment, the instruction set further causes the processing unit to read an adjustment command indicating the repetition count.

In summary, through the light-control instruction extension device and the instruction set of the present invention, a light-control instruction provided by a light-control instruction source may be extended, thereby extending a light-control instruction originally corresponding to a first number of light-emitting elements into a command capable of controlling a second number of light-emitting elements.

### BRIEF DESCRIPTION OF THE DRAWINGS

The drawings provided in the present invention are intended to assist in describing various embodiments of the invention. However, for the purpose of simplifying the drawings and/or highlighting the content to be illustrated, well-known structures and/or elements may be depicted in a simplified schematic manner or may be omitted from the drawings. Moreover, the number of elements shown in the drawings may be singular or plural. The drawings disclosed in the present invention are provided solely for the purpose of illustrating the embodiments and are not intended to limit the scope thereof.

FIG. 1 is a block diagram of a light-control instruction extension device according to one embodiment of the present invention.

FIG. 2 is a schematic diagram illustrating the connection between a light-control instruction source and a light-emitting element group.

FIG. 3 is a schematic diagram of a light-control instruction according to one embodiment of the present invention.

FIG. 4 is a schematic diagram illustrating an application of the light-control instruction extension device according to one embodiment of the present invention.

FIG. 5 is a schematic diagram illustrating a repetition of at least a portion of the light-control instruction according to one embodiment of the present invention.

FIG. 6 is a schematic diagram illustrating the repetition of at least a portion of the light-control instruction based on a quotient according to one embodiment of the present invention.

FIG. 7 is a schematic diagram of an instruction set stored in a storage medium according to one embodiment of the present invention.

FIG. 8 is a flowchart illustrating a command procedure for extending a light-control instruction according to one embodiment of the present invention.

### DETAILED DESCRIPTION

Any reference herein to elements designated by terms such as “first,” “second,” and the like generally does not limit the number or order of such elements. Rather, these terms are used merely as convenient labels for distinguishing between two or more elements or instances thereof. Accordingly, it should be understood that the terms “first,” “second,” and the like in the claims do not necessarily correspond to the same terms used in the written description. Further, it should be understood that references to first and second elements do not imply that only two elements may be employed, nor that the first element must precede the second element. As used herein, terms such as “comprising,” “including,” “having,” and “containing” are open-ended terms and therefore mean “including but not limited to”.

The term “connected” as used herein refers to either a direct or an indirect coupling between two structures. For example, in one instance of indirect connection, one structure may be connected to another structure through an intermediate member.

In the present invention, the terms “exemplary” and “for example” are intended to mean “serving as an example, instance, or illustration.” Any embodiment or aspect described as “exemplary” or “for example” should not necessarily be interpreted as being preferred or advantageous over other aspects of the invention. The terms “about” or “approximately,” when used herein with respect to a specified value or characteristic, are intended to indicate within a certain range of the specified value or characteristic (e.g., within 10%).

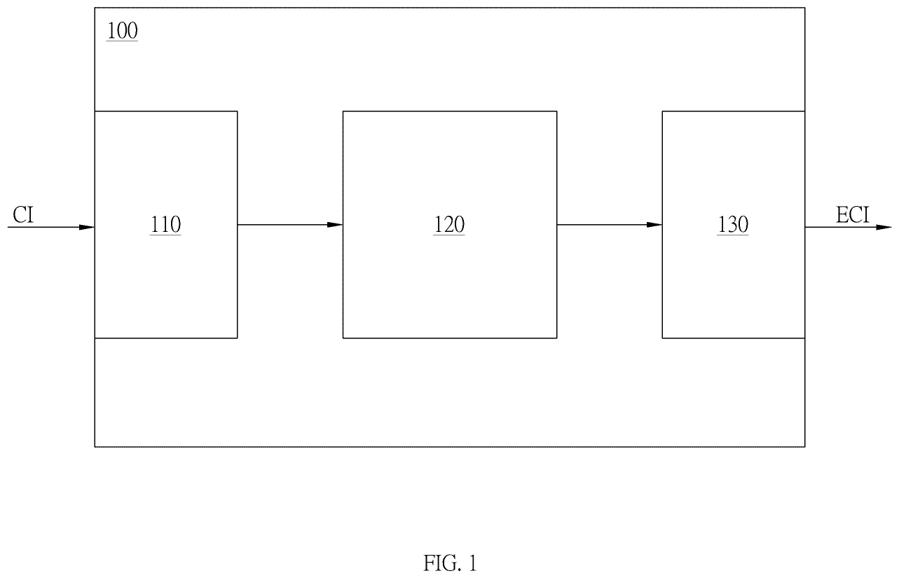

In an embodiment of the present invention, a light-control instruction extension device is provided. Referring to FIG. 1, FIG. 1 illustrates a light-control instruction extension device 100 including an input interface 110, a processing unit 120, and an output interface 130. The input interface 110 is configured to receive a light-control instruction (CI) from a light-control instruction source. The processing unit 120 is configured to receive the light-control instruction (CI) and output an extended light-control instruction (ECI) to a light-emitting element group.

In an embodiment, the light-control instruction source is, for example, a computer motherboard, or a circuit or device formed by a control chip (e.g., MCU, ASIC, or FPGA) for single-wire RGB light-emitting diodes. In an embodiment, the light-control instruction source is configured to output the light-control instruction (CI) to the input interface 110 of the light-control instruction extension device 100 through data transmission protocols such as GPIO, SPI, or I2C. In an embodiment, the input interface 110 of the light-control instruction extension device 100 can be configured by any interface corresponding to the light-control instruction source. For example, the input interface 110 and/or the output interface 130 of the light-control instruction extension device 100 is an ARGB interface. In the embodiment, the ARGB interface is commonly employed for controlling light-emitting elements and helps reduce interface conversion complexity. Therefore, the ARGB interface is compatible with a greater number of existing lighting devices.

In an embodiment, the light-control instruction (CI) includes, for example, a data signal and a latch signal. Specifically, the data signal is configured to represent red (R), green (G), or blue (B) for each light-emitting element by bit signal(s) (e.g., 8 bits). On the other hand, the latch signal is configured to latch the status of each light-emitting element. Once the light-emitting element receives the latch signal, the light-emitting element updates the status according to a corresponding data signal.

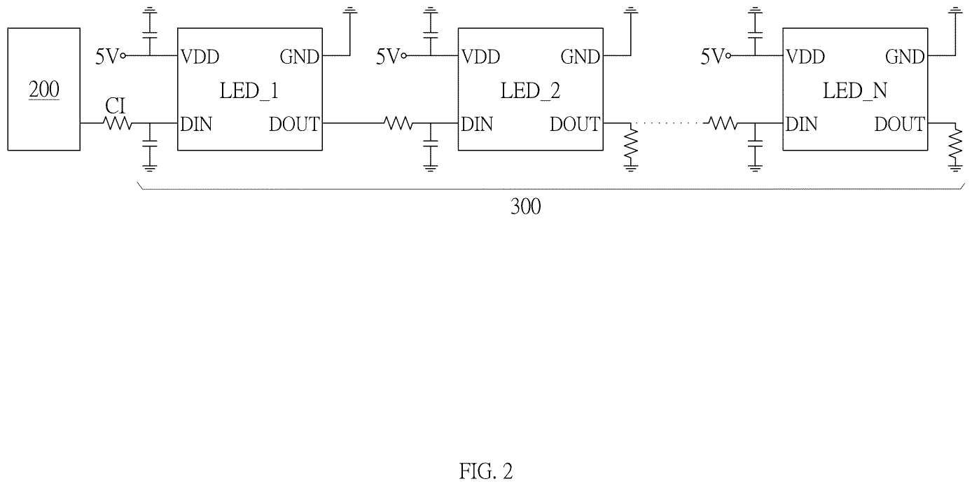

In an embodiment, a first light-emitting element group 300 is formed by cascaded single-wire RGB LEDs. Specifically, the light-emitting elements may be connected in series as shown in FIG. 2. The light-control instruction input (DIN) and the light-control instruction output (DOUT) of adjacent light-emitting elements (LED_1-LED_N) are cascaded accordingly. For example, the light-control instruction input (DIN) of the second light-emitting element (LED_2) is configured to couple with the light-control instruction output (DOUT) of the first light-emitting element (LED_1). In the example, the first light-emitting element (LED_1) receives the light-control instruction (CI) from the light-control instruction source 200 through the light-control instruction input (DIN) of the first light-emitting element (LED_1) and outputs the light-control instruction (CI) from the light-control instruction output (DOUT) of the first light-emitting element (LED_1) to the light-control instruction input (DIN) of the second light-emitting element (LED_2). Accordingly, the light-control instruction (CI) is able to be provided to the light-emitting elements (LED_1-LED_N).

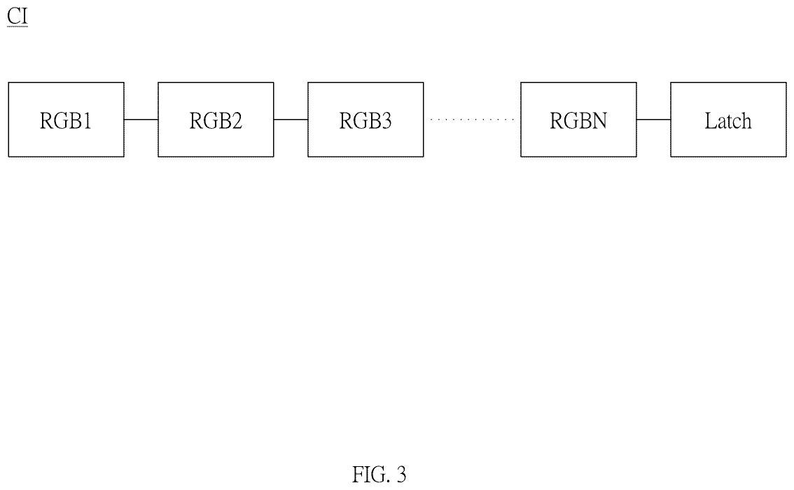

In the embodiment, the transmission of the light-control instruction (CI) is illustrated in FIG. 3. When the light-control instruction (CI) is configured to control the first light-emitting element group 300 having a first number (N) of light-emitting elements, the light-control instruction (CI) includes data signals corresponding to the first light-emitting element (RGB1), the second light-emitting element (RGB2), . . . , and the N-th light-emitting element (RGBN), and a latch signal. As such, the N light-emitting elements of the first light-emitting element group 300 are configured to emit light based on the light-control instruction (CI).

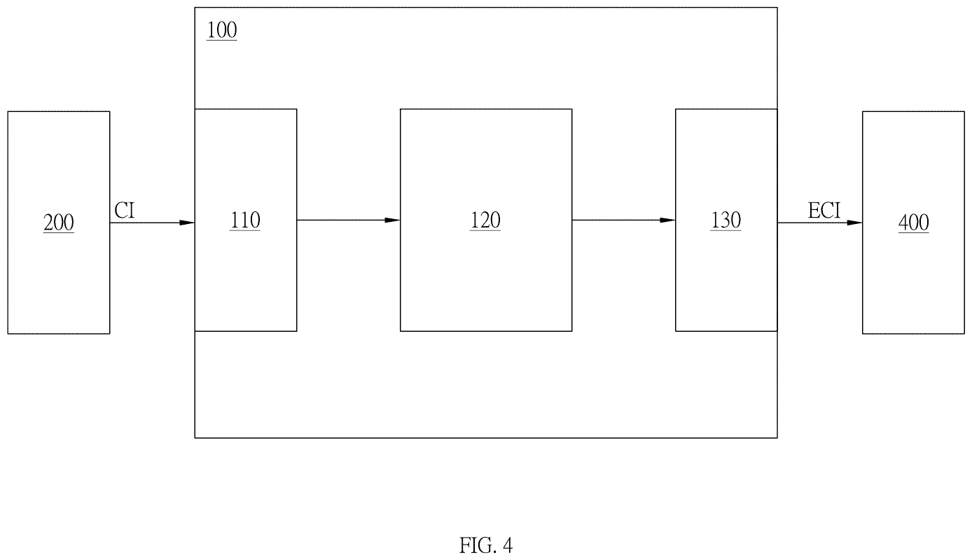

However, when the light-control instruction (CI) is used to control a second light-emitting element group 400 having a second number (M, where M>N) of light-emitting elements, the data signal and/or the latch signal of the light-control instruction (CI) are insufficient to control all light-emitting elements of the second light-emitting element group 400. In other words, the light-control instruction (CI) provided by the light-control instruction source 200 is unable to control the light-emitting elements of the second light-emitting element group 400 beyond the first number (N), i.e., LED_N+1 through LED_M. In such a case, referring to FIG. 4, the light-control instruction extension device 100 is configured to be connected between the light-control instruction source 200 and the second light-emitting element group 400. The processing unit 120 of the light-control instruction extension device 100 is configured to extend the light-control instruction (CI) into an extended light-control instruction (ECI) and outputs it to the second light-emitting element group 400. The processing unit 120 may be an MCU, ASIC, FPGA, or any component capable of instruction reading/processing. The processing unit 120 is configured to read the light-control instruction (CI) corresponding to the first number (N) of light-emitting elements and extend the light-control instruction (CI) into the extended light-control instruction (ECI) corresponding to the second number (M) of light-emitting elements using the extension method described herein.

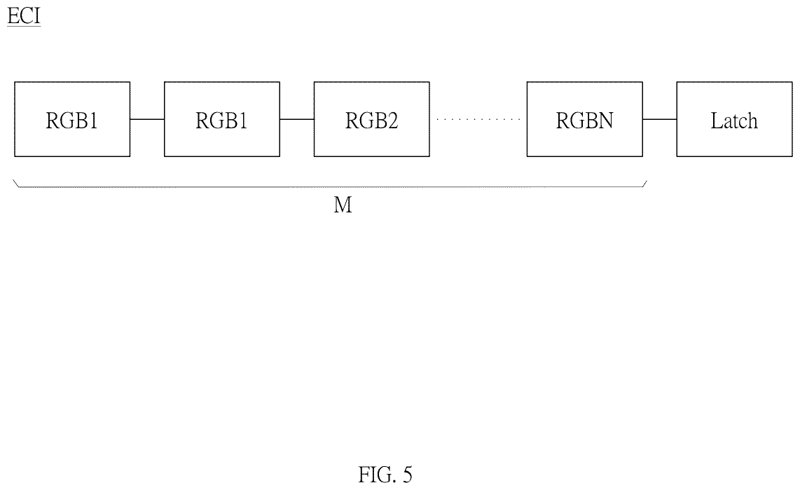

In an embodiment of the extension of the light-control instruction (CI), the processing unit 120 repeats at least a portion of the light-control instruction (CI) to generate the extended light-control instruction (ECI). Referring to FIG. 5, the processing unit 120 is configured to repeat, at least once, at least a portion of the data signals corresponding to the first light-emitting element (RGB1), the second light-emitting element (RGB2), . . . , and/or the N-th light-emitting element (RGBN). Therefore, the amount of data signals in the extended light-control instruction (ECI) is enough to correspond to the second number (M). Specifically, in FIG. 5, the data signal RGB1 is repeated once, thereby making the quantity of data signals in the extended light-control instruction (ECI) equal to the second number (M). It should be noted that FIG. 5 is merely illustrative and does not limit the portions or number of repetitions of the light-control instruction (CI). Moreover, the number of corresponding signals in the extended light-control instruction (ECI) is not limited to the second number (M) and may be any number Y greater than M (Y>M).

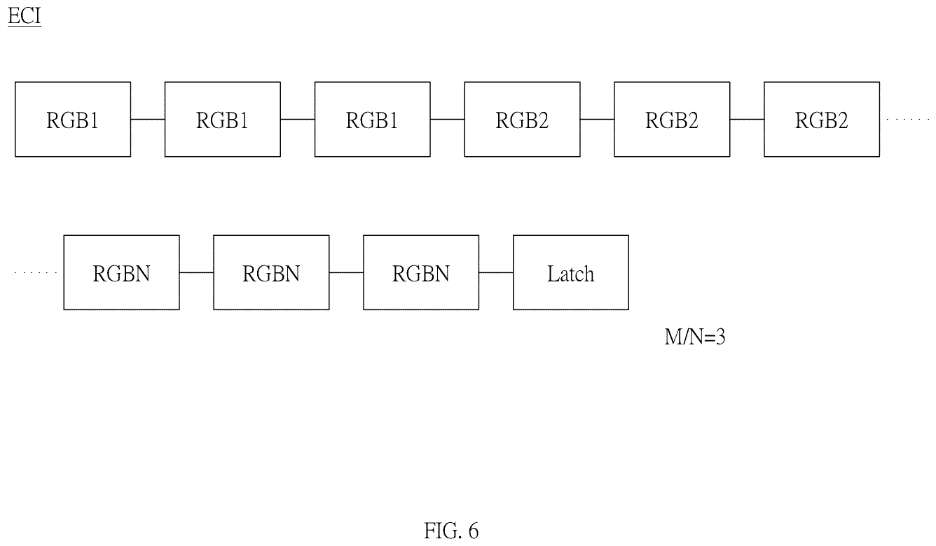

In another embodiment of extending the light-control instruction (CI), the number of repetitions of at least a portion of the light-control instruction (CI) performed by the processing unit 120 is equal to a quotient obtained by dividing the second number by the first number (i.e. M/N). Referring to FIG. 6, for a light-control instruction (CI) corresponding to the first number (N), repetition is performed according to the quotient (M/N). As an example, when the light-control instruction source outputs a light-control instruction (CI) capable of controlling only 80 light-emitting elements (N=80), but the second light-emitting element group has 240 light-emitting elements (M=240), the processing unit 120 is configured to repeat data signals (RGB1-RGB80) three times to generate the extended light-control instruction (ECI). Thus, when the light-control instruction source is insufficient to support the lighting effects of the second light-emitting element group 400, the light-control instruction extension device 100 is configured to extend the light-control instruction (CI) into the extended light-control instruction (ECI) configured to support the lighting effects of the second light-emitting element group 400.

In an embodiment of repeating the light-control instruction (CI), the processing unit 120 is further configured to receive an adjustment command, wherein the adjustment command specifies the number of repetitions (i.e. repetition count) of at least a portion of the light-control instruction (CI). For example, the processing unit 120 is configured to receive the adjustment command provided by a user or a controller via wired means (e.g., signal lines) or wireless means (e.g., Bluetooth). The adjustment command is configured to instruct the number of repetitions of at least a portion of the light-control instruction (CI). For example, if the quotient between the second number (M) and the first number (N) cannot be predetermined or the number of repetitions of at least a portion of the light-control instruction (CI) is not preset in the processing unit 120, the adjustment command is configured to set the number of repetitions of the light-control instruction (CI) to map the first number (N) to the second number (M) after the light-control instruction source 200 and the second light-emitting element group 400 are configured. As a further example, if the adjustment command indicates four repetitions, the adjustment command causes the processing unit 120 to increase the number of data signals from N to 4N. It should be noted that the adjustment command may be set based on the actual number of light-emitting elements to be controlled. For instance, the repetition count may be calculated by dividing M by N or by rounding up to obtain an integer repetition value.

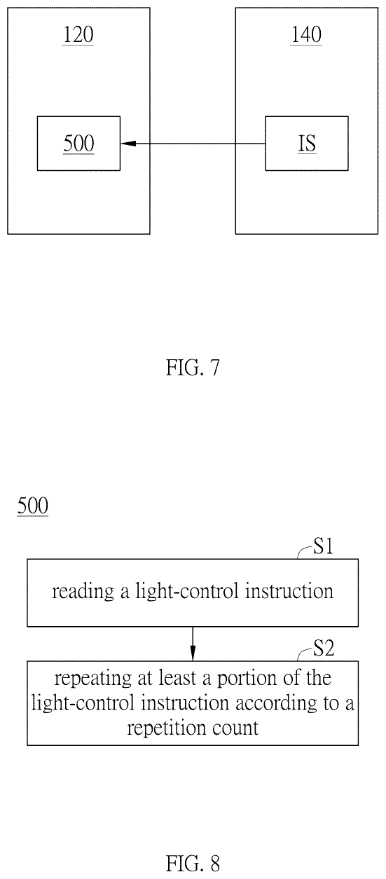

In an embodiment of the present invention, referring to FIGS. 7-8, an instruction set is provided for the light-control instruction extension device. The instruction set is stored in a storage medium (e.g. memory, hard disk or cache). When a processing unit reads the instruction set from the storage medium, the instruction set causes the processing unit to execute a light-control instruction extension method 500. The light-control instruction extension method 500 includes: (Step S1) reading a light-control instruction; and (Step S2) repeating at least a portion of the light-control instruction according to a repetition count.

It should be noted that the instruction set for the light-control instruction extension device may also include instructions for signal transmission, such as initialization instructions for SPI or I2C. Thus, each light-emitting element of the light-emitting element group may be controlled using data transmission protocols such as SPI or I2C.

In an embodiment, the light-control instruction corresponds to a first number of light-emitting elements, and the repetition count is an integer multiple of the first number.

In an embodiment, the instruction set further causes the processing unit to read an adjustment command indicating the repetition count.

In summary, through the light-control instruction extension device and the instruction set of the present invention, a light-control instruction provided by a light-control instruction source may be extended. Thus, a light-control instruction originally corresponding to the control of a first number of light-emitting elements may be extended to control a second number of light-emitting elements.

The foregoing description of the present invention is provided to enable a person skilled in the art to make or use the invention. Various modifications to the invention will be readily apparent to those skilled in the art, and the generic principles defined herein may be applied to other variations without departing from the spirit or scope of the invention. Thus, the present invention is not intended to be limited to the embodiments described herein but is to be accorded the broadest scope consistent with the principles and novel features disclosed.

What is claimed is:

1. A light-control instruction extension device, comprising:
an input interface configured to receive a light-control instruction from a light-control instruction source;
a processing unit configured to receive the light-control instruction and output an extended light-control instruction, wherein the light-control instruction corresponds to a first number of light-emitting elements, the extended light-control instruction corresponds to a second number of light-emitting elements, and the first number is smaller than the second number; and
an output interface configured to output the extended light-control instruction.

2. The light-control instruction extension device of claim 1, wherein the processing unit repeats at least a portion of the light-control instruction to generate the extended light-control instruction.

3. The light-control instruction extension device of claim 2, wherein the number of repetitions of the at least a portion of the light-control instruction performed by the processing unit is equal to a quotient obtained by dividing the second number by the first number.

4. The light-control instruction extension device of claim 2, wherein the processing unit further receives an adjustment command, and wherein the adjustment command indicates a number of repetitions of the at least a portion of the light-control instruction.

5. The light-control instruction extension device of claim 1, wherein the input interface is an ARGB interface.

6. The light-control instruction extension device of claim 1, wherein the light-control instruction source is a motherboard.

7. The light-control instruction extension device of claim 1, wherein the light-emitting element is a single-wire RGB light-emitting diode (LED).

8. An instruction set for extending a light-control instruction, the instruction set being stored in a storage medium, wherein when a processing unit reads the instruction set from the storage medium, the instruction set causes the processing unit to:
read a light-control instruction; and
repeat outputting at least a portion of the light-control instruction according to a repetition count.

9. The instruction set of claim 8, wherein the light-control instruction corresponds to a first number of light-emitting elements, and wherein the repetition count is an integer multiple of the first number.

10. The instruction set of claim 8, wherein the instruction set further causes the processing unit to:
read an adjustment command indicating the repetition count.
